(19) United States
(12) Patent Application Publication
(10) Pub. No.: US 2020/0348519 A1
(43) Pub. Date: Nov. 5, 2020

(54) Waveguide Display with Wide Angle Peripheral Field of View

(71) Applicant: DigiLens Inc., Sunnyvale, CA (US)

(72) Inventors: Jonathan David Waldern, Los Altos Hills, CA (US); Alastair John Grant, San Jose, CA (US); Milan Momcilo Popovich, Leicester (GB)

(73) Assignee: DigiLens Inc., Sunnyvale, CA (US)

(21) Appl. No.: 16/410,905

(22) Filed: May 13, 2019

Related U.S. Application Data
(60) Provisional application No. 62/843,176, filed on May 3, 2019.

(51) Int. Cl. G02B 27/01; G02B 6/122; H04N 13/344

(52) U.S. Cl. CPC G02B 27/0172; H04N 13/344; G02B 27/0176; G02B 6/122

(57) ABSTRACT

Systems and methods for waveguide displays having a wide-angle peripheral field of view in accordance with various embodiments of the invention are illustrated. One embodiment includes a helmet-integrated waveguide display including a helmet, a first picture generation unit (PGU), data communication and power supply links integrated within the helmet, a cable for transmitting signals from the data communication and power supply links to the PGU, and waveguide glasses including a first waveguide for projecting image modulated light from the PGU into an eyebox, and a frame supporting the waveguide, wherein the waveguide has outer edges not abutted by the frame, the waveguide is separated from the PGU by an air space providing unobscured lines of sight between the PGU and the outer edges, and the cable interfaces to the PGU via a self-mating mechanism.

### CROSS-REFERENCE TO RELATED APPLICATIONS

The current application claims the benefit of and priority under 35 U.S.C. § 119(e) to U.S. Provisional Patent Application No. 62/843,176 entitled “Waveguide Display with Wide Angle Peripheral Field of View,” filed May 3, 2019. The disclosure of U.S. Provisional Patent Application No. 62/843,176 is hereby incorporated by reference in its entirety for all purposes.

### FIELD OF THE INVENTION

The present disclosure generally relates to a waveguide device and more particularly to a holographic waveguide display.

### BACKGROUND

Waveguides can be referred to as structures with the capability of confining and guiding waves (i.e., restricting the spatial region in which waves can propagate). One subclass includes optical waveguides, which are structures that can guide electromagnetic waves, typically those in the visible spectrum. Waveguide structures can be designed to control the propagation path of waves using a number of different mechanisms. For example, planar waveguides can be designed to utilize diffraction gratings to diffract and couple incident light into the waveguide structure such that the in-coupled light can proceed to travel within the planar structure via total internal reflection (“TIR”).

Fabrication of waveguides can include the use of material systems that allow for the recording of holographic optical elements within the waveguides. One class of such material includes polymer dispersed liquid crystal (“PDLC”) mixtures, which are mixtures containing photopolymerizable monomers and liquid crystals. A further subclass of such mixtures includes holographic polymer dispersed liquid crystal (“HPDLC”) mixtures. Holographic optical elements, such as volume phase gratings, can be recorded in such a liquid mixture by illuminating the material with two mutually coherent laser beams. During the recording process, the monomers polymerize and the mixture undergoes a photopolymerization-induced phase separation, creating regions densely populated by liquid crystal micro-droplets, interspersed with regions of clear polymer. The alternating liquid crystal-rich and liquid crystal-depleted regions form the fringe planes of the grating.

Waveguide optics, such as those described above, can be considered for a range of display and sensor applications. In many applications, waveguides containing one or more grating layers encoding multiple optical functions can be realized using various waveguide architectures and material systems, enabling new innovations in near-eye displays for augmented reality (“AR”) and virtual reality (“VR”), compact heads-up displays (“HUDs”) for aviation and road transport, and sensors for biometric and laser radar (“LIDAR”) applications.

### SUMMARY OF THE INVENTION

Systems and methods for waveguide displays having a wide-angle peripheral field of view in accordance with various embodiments of the invention are illustrated. One embodiment includes a helmet-integrated waveguide display including a helmet, a first picture generation unit (PGU), data communication and power supply links integrated within the helmet, a cable for transmitting signals from the data communication and power supply links to the PGU, and waveguide glasses including a first waveguide for projecting image modulated light from the PGU into an eyebox, and a frame supporting the waveguide, wherein the waveguide has outer edges not abutted by the frame, the waveguide is separated from the PGU by an air space providing unobscured lines of sight between the PGU and the outer edges, and the cable interfaces to the PGU via a self-mating mechanism.

In another embodiment, the waveguide is disposed in front of a left eye or a right eye.

In a further embodiment, the PGU includes at least one selected from the group of a microdisplay panel, a collimation lens, microdisplay drive electronics, and electronics for switching at least one switchable grating in the waveguide.

In still another embodiment, the self-mating mechanism is magnetic.

In a still further embodiment, the self-mating mechanism is mechanical.

In yet another embodiment, the data communication link is a high definition multimedia interface (HDMI) link.

In a yet further embodiment, the frame are mounted in a track allowing forward or backwards translation of the frame and removal of the frame from the helmet.

In another additional embodiment, the helmet-integrated waveguide display provides an unobscured FOV of at least 105 degrees.

In a further additional embodiment, the PGU housing has slanted surface adjacent the air space.

In another embodiment again, the waveguide has an 8-degree rake angle.

In a further embodiment again, the waveguide has a 15-degree rake angle.

In still yet another embodiment, the frame has features for supporting a prescription lens.

In a still yet further embodiment, the helmet-integrated waveguide display is configured as a motorcycle helmet.

In still another additional embodiment, the data communication link couples the helmet to a remote data source.

In a still further additional embodiment, the helmet-integrated waveguide display provides a color image.

In still another embodiment again, the waveguide supports input coupling grating fold grating and output grating.

In a still further embodiment again, the waveguide supports an input grating and gratings for beam expansion and extraction.

In yet another additional embodiment, the waveguide supports at least one switchable grating.

In a yet further additional embodiment, the helmet-integrated waveguide display further includes a second PGU and a second waveguide, wherein the first PGU and the first waveguide and the second PGU and the second waveguide are symmetrically disposed in the frame.

In yet another embodiment again, the helmet-integrated waveguide display further includes a second waveguide, wherein the first waveguide and the second waveguide are symmetrically disposed in the frame and the PGU can be coupled to the first and second waveguides interchangeably.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which forms a part of this disclosure.

### BRIEF DESCRIPTION OF THE DRAWINGS

The description will be more fully understood with reference to the following figures and data graphs, which are presented as exemplary embodiments of the invention and should not be construed as a complete recitation of the scope of the invention.

FIG. 1 conceptually illustrates a waveguide display implemented in a pair eyeglasses integrated within a helmet in accordance with an embodiment of the invention.

FIGS. 2 and 3 conceptually illustrate two views of the waveguide glasses in accordance with various embodiments of the invention.

FIGS. 4 and 5 conceptually illustrate plan views of two embodiments of the waveguide glasses implementing a PGU.

FIG. 6A conceptually illustrates the waveguide glasses integrated within a helmet in accordance with an embodiment of the invention.

FIG. 6B conceptually illustrates the waveguide glasses superimposed over the helmet in accordance with an embodiment of the invention.

FIG. 7A conceptually illustrates a front view of the integrated display unworn in accordance with an embodiment of the invention.

FIG. 7B conceptually illustrates a side view of the integrated display unworn in accordance with an embodiment of the invention.

FIG. 8A conceptually illustrates a side view of the integrated helmet with the waveguide glasses in position for use in accordance with an embodiment of the invention.

FIG. 8B conceptually illustrates a side view of the integrated helmet with the waveguide glasses fully retracted and disengaged from the magnetic interface in accordance with an embodiment of the invention.

FIGS. 9A-9H conceptually illustrate various configurations for accommodating different head sizes in accordance with various embodiments of the invention.

### DETAILED DESCRIPTION

For the purposes of describing embodiments, some well-known features of optical technology known to those skilled in the art of optical design and visual displays have been omitted or simplified in order to not obscure the basic principles of the invention. Unless otherwise stated, the term “on-axis” in relation to a ray or a beam direction refers to propagation parallel to an axis normal to the surfaces of the optical components described in relation to the invention. In the following description the terms light, ray, beam, and direction may be used interchangeably and in association with each other to indicate the direction of propagation of electromagnetic radiation along rectilinear trajectories. The term light and illumination may be used in relation to the visible and infrared bands of the electromagnetic spectrum. Parts of the following description will be presented using terminology commonly employed by those skilled in the art of optical design. As used herein, the term grating may encompass a grating comprised of a set of gratings in some embodiments. For illustrative purposes, it is to be understood that the drawings are not drawn to scale unless stated otherwise.

Waveguide displays can deliver bright, wide field of view imaging with a comfortable eyebox and can be utilized in a variety of different applications, including but not limited to wearable HUDS. One class of wearable HUDs is described in U.S. patent application Ser. No. 15/863,798 entitled “Wearable Heads Up Display” filed on Jan. 5, 2018, the disclosure of which is hereby incorporated by reference in its entirety for all purposes. Depending on the application, various form factor and safety requirements can exist for wearable HUDs. For example, for waveguide displays designed for motorcycle helmets, there can be stringent safety requirements for peripheral field of view—i.e., the field of view beyond the perimeter of the projected image. In such applications, there is typically a need to accommodate an image generation system (such as a pico projector), often referred to as the Picture Generation Unit (PGU), and additional optics for coupling the image light into the waveguide. Accommodating these components, which can have restrictions in their placements, can be challenging as traditional design implementations restrict the peripheral field of view. Even with the dramatic reduction in the size of pico projector technology seen in recent years, the obscuration of the peripheral field can be objectionable. In some implementations, the use of prismatic relay optics between the PGU and the waveguide can allow some see-through capability at the cost of weight increase. However, the edges of the prisms will still be generally visible. As such, many embodiments of the invention are directed toward compact, efficient waveguide displays with a wide-angle peripheral field of view with minimal to no obscuration.

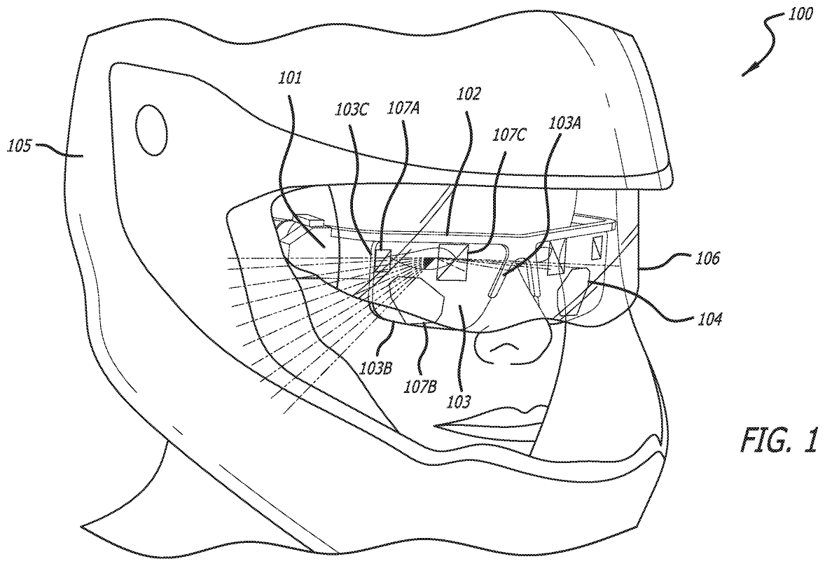

Turning now to the drawings, waveguide displays having a wide-angle peripheral field of view in accordance with various embodiments of the invention are illustrated. FIG. 1 conceptually illustrates a waveguide display implemented in a pair eyeglasses integrated within a helmet in accordance with an embodiment of the invention. As will be explained below, the waveguide glasses can be easily extracted from the helmet for independent operation or for storage. In the illustrative embodiment, the apparatus 100 includes a PGU 101, a waveguide glasses frame 102 supporting waveguide 103 and eyepiece 104. The waveguide glasses are integrated in a helmet 106. In many embodiments, the helmet can incorporate a visor 107. The frame is mounted in a track allowing forward or backwards translation of the frame and removal of the waveguide glasses from the helmet.

In many embodiments, the eyepiece can be a plane glass or plastic substrate. In some embodiments, the eyepiece can be a prescription lens. In the illustrative embodiment, the waveguide is only in contact with the frame along its upper edges and near the nasal region 102A. The lower edge 102B and the outer edge 102C of the waveguide 103 are substantially exposed to minimize the obscuration of the peripheral field. In a number of embodiments, the waveguide 103 has an input grating 105A a fold grating 105B and an output grating 105C. The apparatus 100 can be configured and implemented such that an air gap exists between the PGU 101 and the input grating 105A of the waveguide 103. In several embodiments, obscuration can be further mitigated by angling the faces of the PGU housing nearest the waveguide.

In many embodiments, a second PGU and a second waveguide (replacing the eyepiece 104) can be provided to enable the presentation of imagery to both eyes with the PGUs and waveguides disposed symmetrically in the frame. In some embodiments, a second waveguide is provided (disposed symmetrically to the first) such that a single PGU can be configured for viewing via either of the two waveguides.

Data communication and power supply links can be integrated within the helmet. In many embodiments, the data communication link is a high definition multimedia interface (HDMI) link. In some embodiments, a cable for transmitting signals for data communication and power to the PGU is provided. The cable can interface with the PGU via a self-mating mechanism such that the cable disconnects effortlessly when the glasses are removed. The connector can also self-align when the glasses are put on. In several embodiments, the self-mating mechanism is magnetic. In a number of embodiments, the self-mating mechanism is mechanical.

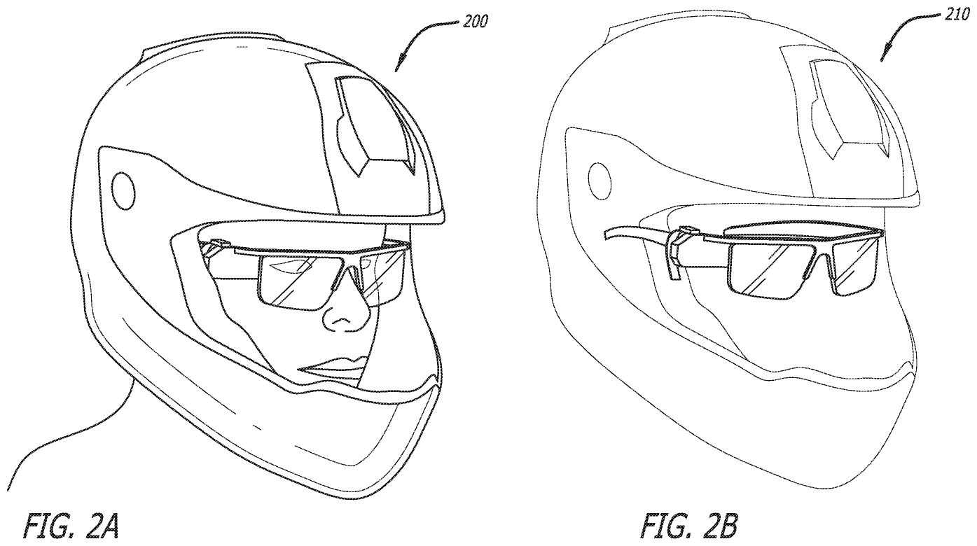

FIG. 2 conceptually illustrates a side view of the waveguide glasses in accordance with an embodiment of the invention. As shown, FIG. 2 is a view 110 of the waveguide glasses showing a frame portion 112 for securing the display to the temples of the user's head. To give some idea of the extent of the unobscured peripheral field of view, FIG. 2 also shows horizontal (113) and vertical (114) field of view directions in 5-degree steps. In the illustrative embodiment, the waveguide glasses are mounted on the user's head and not attached to a helmet. In such implementations, the data communication and power supply links can be integrated within the helmet. This allows the glasses to be adjusted for different head sizes similar to conventional eyewear. FIG. 3 shows another view 120 of the waveguide glasses. In some embodiments, the data source and/or power supply can be integrated within the helmet. In many embodiments, the data source and/or power supply are remote from the helmet.

In the illustrative embodiment of FIG. 2, the power/HDMI cable is magnetically attached to the glasses such that the cable can disconnect automatically when the glasses are removed from the connected position. Likewise, the connector can be configured to self-align when the glasses are moved into position. To minimize peripheral obscuration, the optical path between the projector and the waveguide can be unobstructed, which also results in the reduction of weight for the device. To further minimize obscuration, at least a portion of the outer edge of the waveguide can be frameless (as shown in FIG. 2).

In many embodiments, the frame can have features for supporting prescription lenses for one or both eyes. In many embodiments, the display is configured for use as a motorcycle helmet HUD. The waveguide optical design can have many different forms. In many embodiments, the waveguide supports an input coupling grating, a fold grating and an output grating. In many embodiments, the waveguide can support an input grating and gratings for beam expansion and extraction. In many embodiments, the waveguide can support at least one switchable grating.

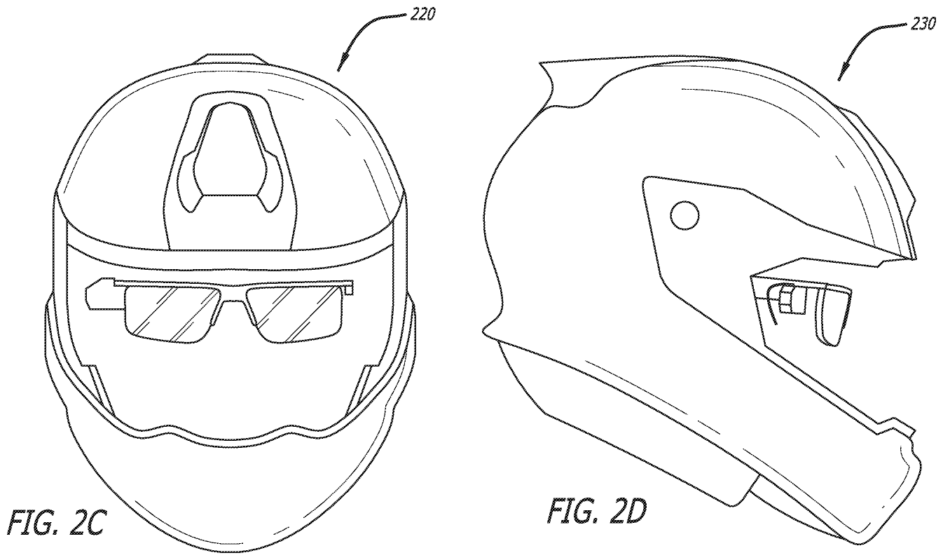

FIG. 4 conceptually illustrates a plan view 130 of one embodiment of the waveguide glasses showing a PGU 131 and an output portion of the PGU 132. In the illustrative embodiment, an 8-degree rake angle (waveguide tilt angle) is utilized to achieve a 105-degree unobscured field of view. The design provides a 9.5 mm. eye relief. The line 133 represents the edge of the line of sight for achieving the 105-degree field of view.

FIG. 5 conceptually illustrates a plan view 140 of another embodiment of the waveguide glasses showing a PGU 141 and an output portion of the PGU 142. In the illustrative embodiment, a 15-degree rake angle is utilized to achieve a 105-degree unobscured field of view. The design provides a 13.9 mm. eye relief. In many embodiments, the eye relief and the projector relief can both be increased to allow the projector to be pushed further back from the eyepiece waveguide. In FIG. 5, a magnetic connection mechanism 144,145 for a power HDMI cable 143 is also implemented.

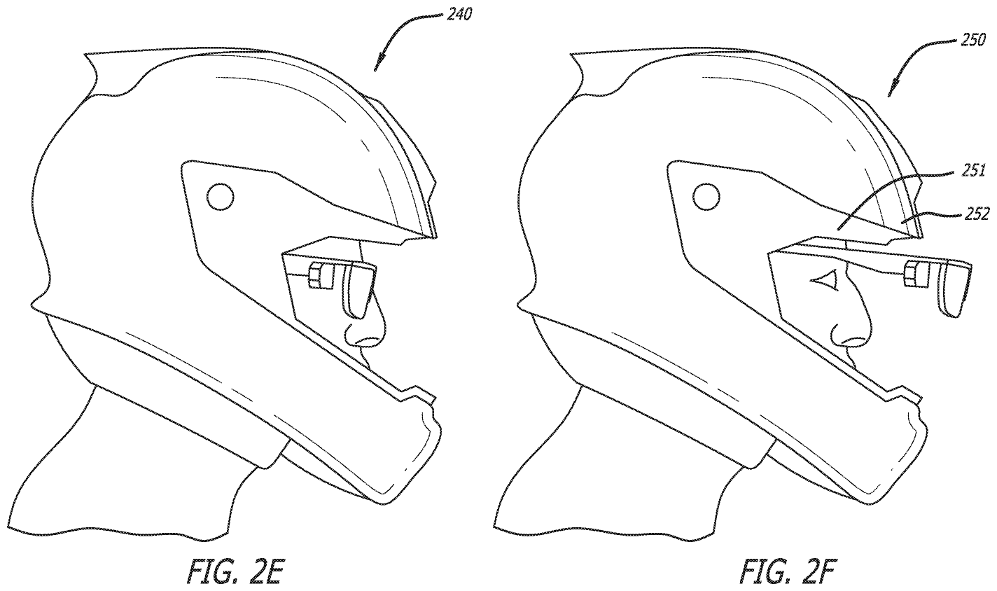

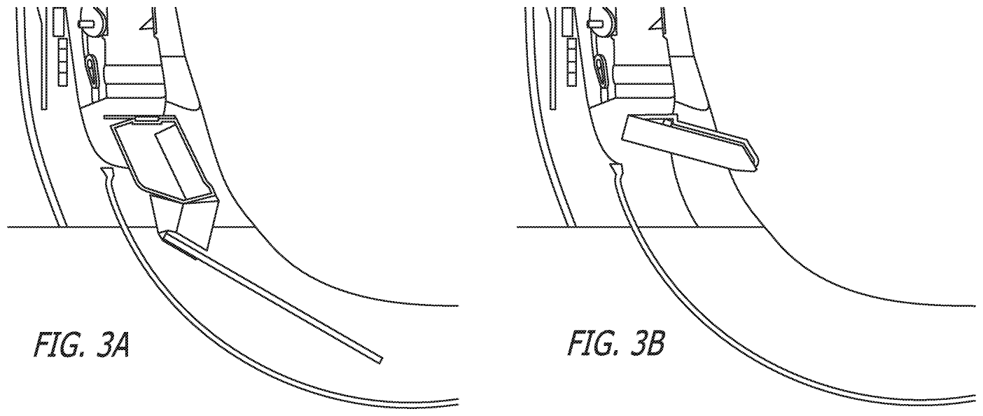

FIG. 6A conceptually illustrates the wearables integrated within a helmet in accordance with an embodiment of the invention. FIG. 6B conceptually illustrates the waveguide glasses superimposed over the helmet in accordance with an embodiment of the invention.

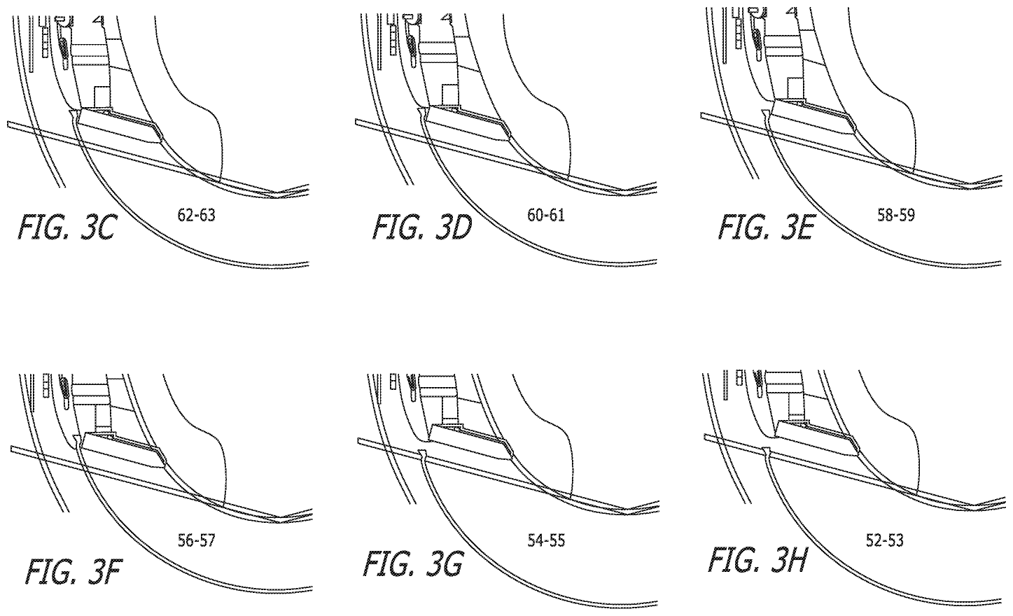

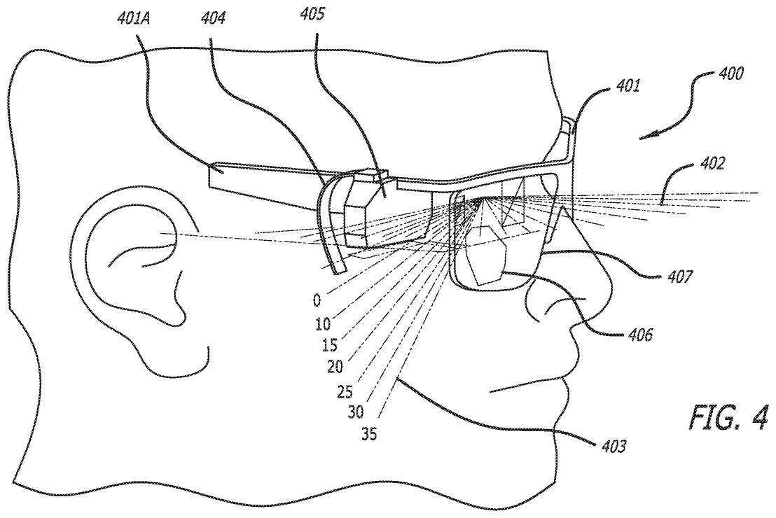

FIG. 7A conceptually illustrates a front view 170 of the integrated display unworn in accordance with an embodiment of the invention. FIG. 7B conceptually illustrates a side view 180 of the integrated display unworn in accordance with an embodiment of the invention.

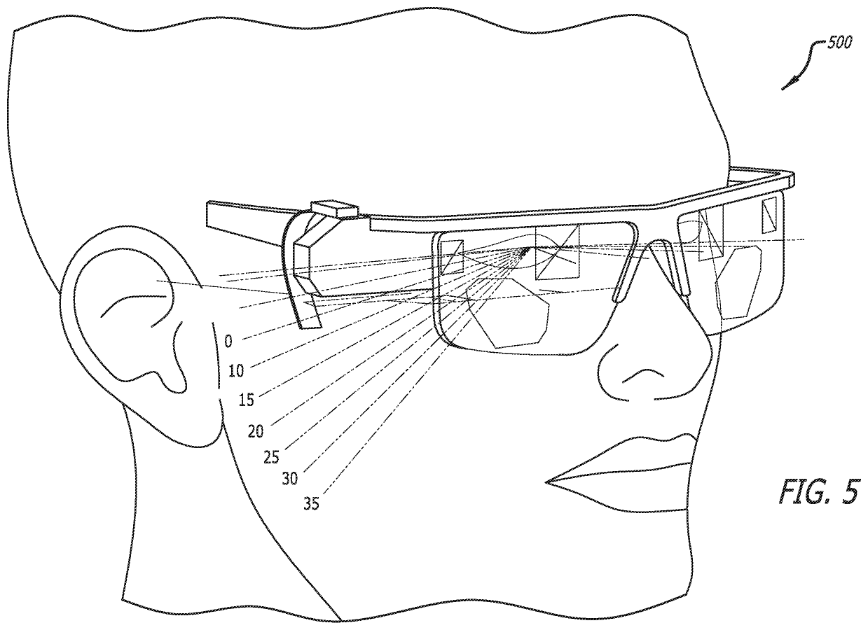

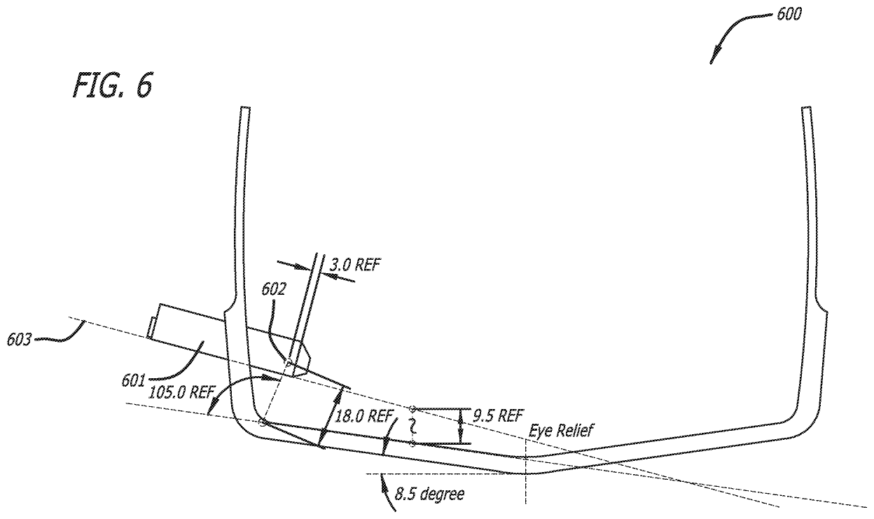

FIG. 8A conceptually illustrates a side view 190 of the integrated helmet with the waveguide glasses in position for use in accordance with an embodiment of the invention. FIG. 8B conceptually illustrates a side view 200 with the waveguide glasses fully retracted and disengaged from the magnetic interface 144, 145 in accordance with an embodiment of the invention.

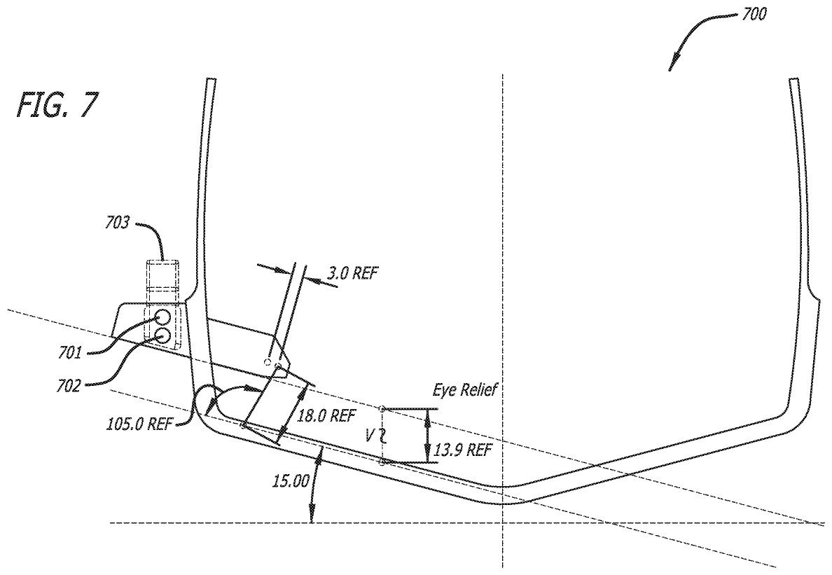

FIGS. 9A-9H conceptually illustrate various configurations for accommodating different head sizes in accordance with various embodiments of the invention. As shown, for larger head sizes, the glasses can move forward as the head size increases (eye position moves forward). FOV can be maintained as the glasses move with increasing head sizes.

### DOCTRINE OF EQUIVALENTS

While the above description contains many specific embodiments of the invention, these should not be construed as limitations on the scope of the invention, but rather as an example of one embodiment thereof. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

1. A helmet-integrated waveguide display comprising:
a helmet;
a first picture generation unit (PGU);
data communication and power supply links integrated within said helmet;
a cable for transmitting signals from said data communication and power supply links to said PGU; and
waveguide glasses comprising:
a first waveguide for projecting image modulated light from said PGU into an eyebox; and
a frame supporting said waveguide, wherein:
said waveguide comprises at least one switchable grating, wherein switching of the grating is controlled by said PGU;
said waveguide has outer edges not abutted by said frame,
said waveguide is separated from said PGU by an air space providing unobscured lines of sight between said PGU and said outer edges such that said helmet-integrated waveguide display provides an unobscured FOV of at least 105 degrees, and
said cable interfaces to said PGU via a self-mating mechanism.

2. The helmet-integrated waveguide display of claim 1, wherein said waveguide is disposed in front of a left eye or a right eye.

3. The helmet-integrated waveguide display of claim 1, wherein said PGU comprises at least one selected from the group of a microdisplay panel, a collimation lens, microdisplay drive electronics, and electronics for switching at least one switchable grating in said waveguide.

4. The helmet-integrated waveguide display of claim 1, wherein said self-mating mechanism is magnetic.

5. The helmet-integrated waveguide display of claim 1, wherein said self-mating mechanism is mechanical.

6. The helmet-integrated waveguide display of claim 1, wherein said data communication link is a high definition multimedia interface (HDMI) link.

7. The helmet-integrated waveguide display of claim 1, wherein said frame are mounted in a track allowing forward or backwards translation of the frame and removal of the frame from said helmet.

8. (canceled)

9. The helmet-integrated waveguide display of claim 1, wherein said PGU housing has slanted surface adjacent said air space.

10. The helmet-integrated waveguide display of claim 1, wherein said waveguide has an 8-degree rake angle.

11. The helmet-integrated waveguide display of claim 1, wherein said waveguide has a 15-degree rake angle.

12. The helmet-integrated waveguide display of claim 1, wherein said frame has features for supporting a prescription lens.

13. The helmet-integrated waveguide display of claim 1, wherein said helmet-integrated waveguide display is configured as a motorcycle helmet.

14. The helmet-integrated waveguide display of claim 1, wherein said data communication link couples said helmet to a remote data source.

15. The helmet-integrated waveguide display of claim 1, wherein said helmet-integrated waveguide display provides a color image.

16. The helmet-integrated waveguide display of claim 1, wherein said waveguide supports input coupling grating fold grating and output grating.

17. The helmet-integrated waveguide display of claim 1, wherein said waveguide supports an input grating and gratings for beam expansion and extraction.

18. (canceled)

19. The helmet-integrated waveguide display of claim 1, further comprising a second PGU and a second waveguide, wherein said first PGU and said first waveguide and said second PGU and said second waveguide are symmetrically disposed in said frame.

20. The helmet-integrated waveguide display of claim 1, further comprising a second waveguide, wherein said first waveguide and said second waveguide are symmetrically disposed in said frame and said PGU can be coupled to said first and second waveguides interchangeably.
